(19) United States
(12) Patent Application Publication
(10) Pub. No.: US 2006/0146381 A1
(43) Pub. Date: Jul. 6, 2006

(54) Image sensor having color wheel

(76) Inventor: Sang Sik Kim, Suwon-city (KR)

Correspondence Address: MCKENNA LONG & ALDRIDGE LLP;Song K. Jung, 1900 K Street, N.W., Washington, DC, 20006, US

(21) Appl. No.: 11/319,571

(22) Filed: Dec. 29, 2005

(30) Foreign Application Priority Data
Dec. 30, 2004 (KR) 10-2004-0116513

(51) Int. Cl. H04N 1/46

(52) U.S. Cl. 358/514

(57) ABSTRACT

An image sensor having a color wheel includes a plurality of pixels, an image sensing portion for sensing an optical signal for each pixel, a controller for processing the sensed optical signal for each pixel, an image sensor package for receiving the image sensing portion and the controller, wherein the controller has an upper side formed of a lid, and a color filter portion disposed adjacent the lid. The lid may be transparent. Thus, instead of forming a color filter layer in an on-chip type device, the color filter portion is formed near a top of a glass lid of a packaged image sensor. The driving of the color filter portion is controlled so as to sense color information.

### This application claims the benefit of Korean Patent Application No. 10-2004-0116513, filed on Dec. 30, 2004, which is hereby incorporated by reference for all purposes as if fully set forth herein.

### BACKGROUND OF THE INVENTION

1. Field of the Invention

The present invention relates to an image sensor, and more particularly, to an image sensor having a color wheel, in which a color filter portion is formed near the top of a glass lid. The driving of the color filter portion is controlled so as to sense color information.

2. Discussion of the Related Art

In fabricating an image sensor, color separation may be achieved using a dichromic mirror of a prism so that a chromatic signal may enter each of a plurality of black-and-white charge-coupled devices. Color separation may also be achieved by forming a color filter layer, including a color filter for each pixel, on an upper portion of the image sensor. The color filter layer is formed as an on-chip type component of the image sensor, whereby a plurality of color filters corresponding to a pixel array is integrated with other image sensor components, to be formed on a single chip. Color information between pixels is interpolated by the color filter layer to separate a chromatic signal from a luminance signal.

The information between pixels may be combined and then extracted by an interpolation step. The interpolation step may include a color recovery step. Thus, the resolution of an image sensor has no direct correspondence with the number of pixels. For example, to obtain television-quality resolution, the number of effective pixels should be at least doubled. However, this necessitates decreasing the size of a unit pixel and therefore degrades photosensitivity. Directly doubling the pixel count is limited by the size of an image sensor and its fabrication process, which becomes very complicated and costly when higher resolutions are sought. Securing very high levels of resolution, such as HDTV-quality resolution, is difficult as the interpolation and color recovery causes a variety of problems, including severe blurring. Therefore, an algorithm for color reproduction is necessary.

Furthermore, in the case of a three-chip type black-and-white image sensor using charge-coupled devices, the size or volume of such a device is determined by the number of prisms and related components necessary to make up the pixel array. Accordingly, the resulting device may be too large for general purpose applications.

### SUMMARY OF THE INVENTION

Accordingly, the present invention is directed to an image sensor having a color wheel that substantially obviates one or more problems due to limitations and disadvantages of the related art.

An advantage of the present invention is to provide an image sensor having a color wheel, in which high-quality color is displayed in a black-and-white image sensor without a deterioration of television-quality resolution and without increasing the overall volume of the device.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, there is provided an image sensor including a plurality of pixels, an image sensing portion for sensing an optical signal for each pixel, a controller for processing the sensed optical signal for each pixel, an image sensor package for receiving the image sensing portion and the controller, wherein the image sensor package has an upper side formed of a lid, and a color filter portion disposed adjacent the lid.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiment(s) of the invention and together with the description serve to explain the principles of the invention. In the drawings:

FIG. 1 is a perspective view of an image sensor;

FIG. 2 is a perspective view of a packaged image sensor; and

FIG. 3 is a diagram of a packaged image sensor having a color filter portion according to the present invention.

### DETAILED DESCRIPTION OF THE INVENTION

Reference will now be made in detail to exemplary embodiments of the present invention, examples of which are illustrated in the accompanying drawings. Wherever possible, like reference designations will be used throughout the drawings to refer to the same or similar parts.

An image sensor of the present invention may be formed on a silicon wafer using general processes for fabricating a CCD- or CMOS-type image sensor. A CCD-type image sensor is a charge-coupled device type image sensor and a CMOS-type image sensor is a complementary metal oxide semiconductor type image sensor. The image sensor may be packaged using general processes for packaging the device.

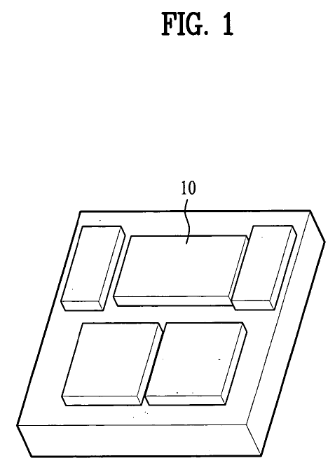

Referring to FIG. 1, a CMOS image sensor includes an image sensing portion 10, a timing generator (not shown), an analog-to-digital converter(not shown), an analog front end (not shown), such as a digital signal processor, and an image signal processor (not shown), all of which may be integrated on one chip. The image sensing portion occupies approximately 20 to 30% of the surface area of the entire chip.

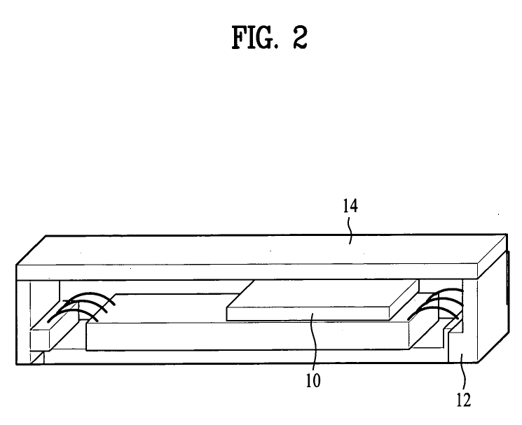

Referring to FIG. 2, a packaged image sensor device is illustrated. A chip having an image sensing portion 10 is arranged in a package frame 12 having a lid 14. The lid 14 may be transparent. Additionally, the lid may be made of glass. Thus, the lid 14 seals an upper side of the image sensor package, which comprises the package frame 12 having an open top for receiving the lid. The top of the image sensing portion 10 is disposed directly under a lower surface of the lid. A separately fabricated color filter portion includes a rotational plate, such as a color wheel, mounted onto the packaged image sensing portion. The rotational plate, such as the color wheel, of the color filter portion is mounted on the package of the image sensor. Thus, a color image sensor that can enable color separation is obtained.

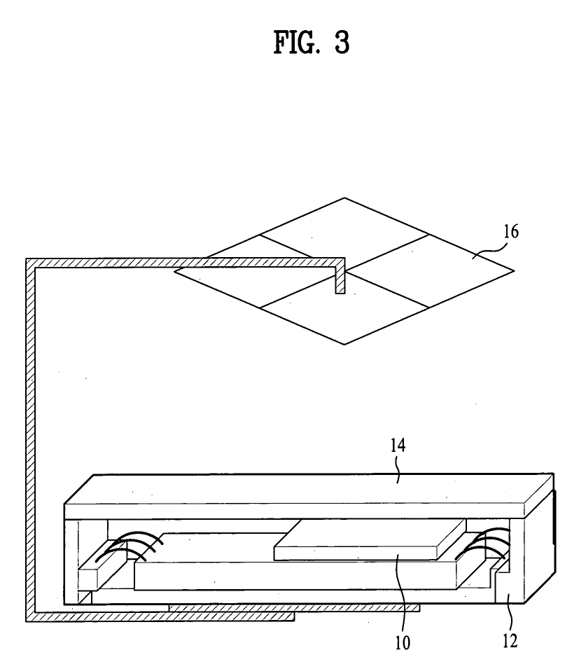

Referring to FIG. 3, a packaged image sensor having a color filter portion according to the present invention is illustrated. A color wheel 16 may be arranged on the packaged image sensor of FIG. 2, and a controller controls a rotational speed of the color wheel. Therefore, in the image sensor according to the present invention, instead of forming a color filter layer in an on-chip type device, the color filter portion is formed adjacent an upper surface of the lid, which may be transparent, of the packaged image sensor. The driving of the color filter portion may be controlled so as to sense color information, for example, red, green, blue, and white color components.

In the present invention, the package and the color wheel of the color filter portion may be formed in one chip. Also, the color filter portion may be formed with various shapes to provide color separation for three or more colors. The square color wheel of an exemplary embodiment of the present invention provides red, green, blue, and white separation. However, other embodiments of the present invention, including other color combinations, may be provided to enable color separation. For example, a color combination may include red, green, and blue color components.

The color filter portion can be mounted on the packaged image sensor very close to the top of the lid as shown in FIG. 2 because the package of the image sensor has a two-dimensional area of approximately 20% to 30%. The color filter portion can be driven using a micromotor. In this case, the rotational speed of the color filter portion can be controlled by the sensor's image signal processor. The rotational speed of the color filter portion, such as the color wheel, can be controlled by a frame rate of the image sensor. This enables a chromatic signal and a luminance signal to be obtained by the color filter portion of the present invention. Once the color filter portion, such as the color wheel, obtains a chromatic signal, further color information can be determined for the same pixel. Therefore, since external color information is obtained in one pixel, a resolution corresponding to the number of pixels can be obtained without distortion.

The image sensor according to the present invention may further include an infrared cutoff filter (not shown) or an optical low-pass filter (not shown) provided adjacent one surface of the color filter portion 10. The filter may be provided at the top or bottom surface of the color filter portion 10.

Instead of forming a color filter layer in an on-chip type device, the color filter portion is formed near the top of the lid, which may be transparent, of the packaged image sensor. A resolution of two times or greater can be obtained using the same number of pixels as in the related art. An exact image can be sensed since no interpolation between adjacent pixels is performed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An image sensor, comprising:
a plurality of pixels;
an image sensing portion for sensing an optical signal for each pixel;
a controller for processing the sensed optical signal for each pixel;
an image sensor package for receiving said image sensing portion and said controller, wherein said image sensor package has an upper side formed of a lid; and
a color filter portion disposed in an area above said lid.

2. The image sensor of claim 1, wherein said lid is a transparent lid.

3. The image sensor of claim 2, wherein said color filter portion includes a rotational plate divided into a number of colors.

4. The image sensor of claim 3, wherein said rotational plate is rotated at a rotational speed controlled by said controller.

5. The image sensor of claim 2, wherein said image sensing portion and said controller are formed on one chip.

6. The image sensor of claim 2, wherein the transparent lid is formed of glass.

7. The image sensor of claim 2, wherein the transparent lid seals the upper side of said image sensor package.

8. The image sensor of claim 2, wherein said image sensor package includes a package frame having an open top for receiving the transparent lid.

9. The image sensor of claim 2, further comprising:
an infrared cutoff filter provided in said color filter portion.

10. The image sensor of claim 9, wherein said infrared cutoff filter is provided adjacent one surface of said color filter portion.

11. The image sensor of claim 2, further comprising:
an optical low-pass filter provided in said color filter portion.

12. The image sensor of claim 11, wherein said optical low-pass filter is provided adjacent one surface of said color filter portion.

13. The image sensor of claim 2, wherein said image sensing portion includes a sectional structure of a photodiode, a light-transmitting layer, and a microlens layer formed on a silicon wafer.

14. The image sensor of claim 3, wherein the rotational plate is a color wheel.

15. The image sensor of claim 2, wherein the color filter portion is adjacent said lid.

16. In a packaged image sensor including an image sensing portion and a controller for processing a sensed pixel in one chip, the image sensor being arranged in a package frame whose top is sealed with a glass lid, the packaged image sensor characterized in that a color filter portion is formed at a top of the glass lid.
